(19) United States
(12) Patent Application Publication
(10) Pub. No.: US 2021/0070376 A1
(43) Pub. Date: Mar. 11, 2021

(54) VEHICLE BODY LOWER STRUCTURE

(71) Applicants: TOYOTA JIDOSHA KABUSHIKI KAISHA, Aichi (JP); SUBARU CORPORATION, Tokyo (JP)

(72) Inventors: Naoki TAKAHASHI, Miyoshi-shi (JP); Shin INOUE, Okazaki-shi (JP); Shunji SHIBATA, Anjo-shi (JP)

(21) Appl. No.: 17/012,051

(22) Filed: Sep. 4, 2020

(30) Foreign Application Priority Data
Sep. 6, 2019 (JP) 2019-162993

(51) Int. Cl. B62D 27/06; B60K 1/04; B62D 21/15; B62D 25/02

(52) U.S. Cl. CPC B62D 27/065; B60K 1/04; B60K 2001/0438; B62D 25/025; B62D 21/157

(57) ABSTRACT

A vehicle body lower structure may comprise: a rocker arranged at a lower lateral part of a vehicle body and extending along a front-rear direction of the vehicle body; a power supply package arranged under a floor panel of the vehicle body; and a hollow beam extending along the front-rear direction and fixed to the power supply package, the hollow beam including an upper plate, a lower plate, and a vertical plate, and the vertical plate connecting the upper plate and the lower plate. The hollow beam may be fixed to the rocker by a bolt penetrating the upper plate and the lower plate, and a head of the bolt may overlap the vertical plate in an axial direction of the bolt, and/or a washer through which the bolt extends overlaps the vertical plate in the axial direction.

### CROSS-REFERENCE TO RELATED APPLICATION

This application claims priority to Japanese Patent Application No. 2019-162993 filed on Sep. 6, 2019, the contents of which are hereby incorporated by reference into the present application.

### TECHNICAL FIELD

The art disclosed herein relates to a vehicle body lower structure. It relates in particular to a vehicle body lower structure in which a power supply package is disposed under a floor panel.

### BACKGROUND

In some electric vehicles, a power supply package configured to supply power to a traction motor is arranged under a floor panel. The power supply package is arranged between a pair of rockers. Japanese Patent Application Publication Nos. 2018-75939 (Literature 1), 2019-6303 (Literature 2), and 2013-256265 (Literature 3) describe examples of such an electric vehicle. The pair of rockers is a frame extending along a front-rear direction of a vehicle body at lateral sides of a lower part of each vehicle body. The rockers may be sometimes referred to as “side sills”. The power supply package may include a battery, a fuel cell, and the like.

In order to protect the power supply package from an impact of lateral collision from a lateral side of a vehicle body, there may be a case where a member configured to absorb impact energy (energy absorbing member) by the shock is arranged along each of the rockers. Literatures 1 and 3 describe examples of such an energy absorbing member.

In the vehicle body lower structure described in Literature 1, the power supply package is fixed to a side member.

### SUMMARY

The energy absorbing member is a hollow beam. If a power supply package is fixed to a side member, the power supply package and the side member overlap each other in a space between a floor panel and a ground, thus a ground height of the floor panel becomes high. If the power supply package can be fixed to the hollow beam (energy absorbing member), the side member arranged under or above the power supply package will be unnecessary, as a result of which the ground height of the floor panel can be lowered. The hollow beam needs to he rigidly fixed to a rocker in order for it to stably support the power supply package, which has a large weight.

A vehicle body lower structure may comprise: a rocker arranged at a lower lateral part of a vehicle body and extending along a front-rear direction of the vehicle body; a power supply package arranged under a floor panel of the vehicle body; and a hollow beam extending along the front-rear direction and fixed to the power supply package, the hollow beam including an upper plate, a lower plate, and a vertical plate, and the vertical plate connecting the upper plate and the lower plate. The hollow beam may be fixed to the rocker by a bolt penetrating the upper plate and the lower plate, and a head of the bolt may overlap the vertical plate in an axial direction of the bolt, and/or a washer through which the bolt extends overlaps the vertical plate in the axial direction.

The hollow beam corresponds to the aforementioned energy absorbing member. The hollow energy absorbing member is configured to absorb collision energy generated by an impact of collision by collapsing upon the collision from a lateral side. The energy absorbing member is fastened to the rocker by the bolt. With an energy absorbing member having a simple hollow structure, the energy absorbing member may be undesirably deformed when the bolt is very tightly fastened thereon. To address this, the vertical plate connecting the upper plate and the lower plate is provided within the energy absorbing member. The vertical plate overlaps the head of the bolt as seen along the axial direction of the bolt and/or overlaps the washer through which the bolt extends as seen along the axial direction of the bolt. Since a fastening force transmits directly to the vertical plate, the hollow energy absorbing member may not be deformed and the energy absorbing member is rigidly fixed to the rocker.

Details and further developments of the art disclosed herein will be described in DETAILED DESCRIPTION as below.

### BRIEF DESCRIPTION OF DRAWINGS

FIG. 1 illustrates a perspective view of a vehicle body.

FIG. 2 illustrates a cross-sectional view of the vehicle body taken along a plane II of FIG. 1.

FIG. 3 illustrates a bottom view of a surround of a bolt.

### DETAILED DESCRIPTION

### Embodiment

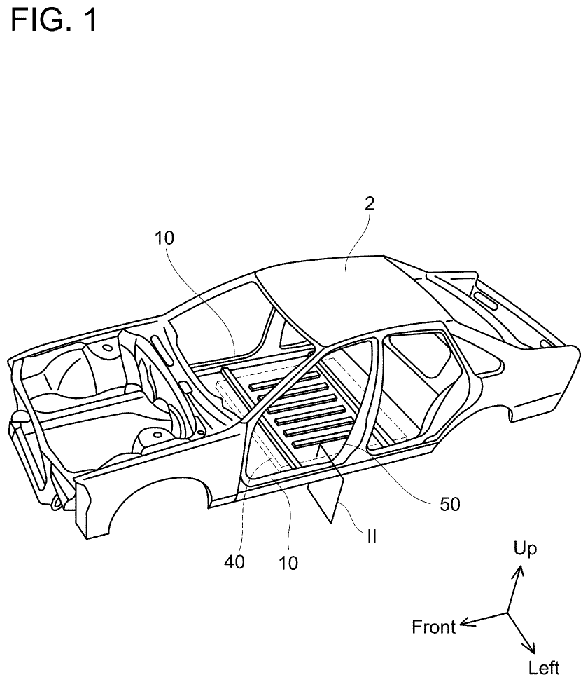

A vehicle body lower structure 3 according to an embodiment will be described with reference to the drawings. FIG. 1 illustrates a perspective view of a vehicle body 2. “Left” in a coordinate system of FIG. 1 indicates “left” in a case of seeing a front side from a rear side of the vehicle body. The “Left” in the coordinate system has a like meaning in all of the drawings.

The vehicle body 2 comprises a pair of rockers 10. Each of the rockers 10 is arranged at a corresponding lateral side of a lower part of the vehicle body 2 in a vehicle-width (left-right) direction of the vehicle body 2. Each rocker 10 is hollow, has an elongated shape, and extends along a front-rear direction of the vehicle body. The pair of rockers 10 is one type of frames configured to secure rigidity of the vehicle body. The rockers 10 are made by extrusion molding of a metal (typically, aluminum).

A power supply package 40 and a floor panel 50 are arranged between the pair of rockers 10. The power supply package 40 incorporates a large number of battery cells therein. The battery cells are connected in series, and configured to output high-voltage power. The power supply package 40 is configured to supply the power to a traction motor (riot shown). The power supply package 40 may be a collective body of fuel cells.

The floor panel 50 corresponds to a floor of a cabin. Each side of the floor panel 50 is fixed to corresponding one of the rockers 10. The power supply package 40 is arranged under the floor panel 50. Although details will be described later, an energy absorbing member (not shown in FIG. 1) is arranged along the rockers 10, and the power supply package 40 is supported by the pair of rockers 10 via the energy absorbing member. Hereafter, the energy absorbing member will be referred to as an EA member (Energy Absorbing member) for convenience of description.

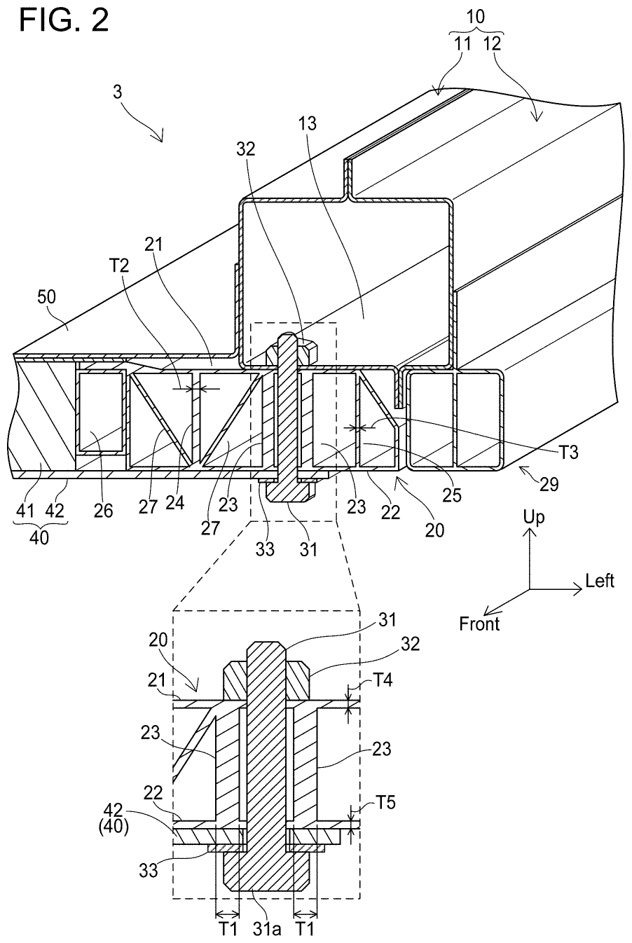

FIG. 2 shows a cross section of the vehicle body 2 cut along a plane II of FIG. 1. FIG. 2 shows the lower structure 3 on a left side of the vehicle body 2. The vehicle body 2 is symmetrical in the left-right direction, and the lower structure 3 on a right side of the vehicle body 2 has a same structure as that of FIG. 2. Accordingly, a description of the lower structure of the right side of the vehicle body 2 will be omitted.

An overview of the vehicle body lower structure 3 will be described. Each of the rockers 10 is constituted of a rocker inner panel 11 and a rocker outer panel 12. The rocker inner panel 11 and the rocker outer panel 12 each have a flange extending along an up-down direction, and are welded to each other at their flange surfaces that face each other. Each rocker 10 has a hollow, cornered tubular shape extending along a vehicle body front-rear direction. A nut 32 is fixed on an inner side of a bottom plate 13 of the rocker inner panel 11. The nut 32 is welded to the rocker inner panel 11 prior to welding the rocker inner panel 11 and the rocker outer panel 12 to each other.

An EA member 29 (energy absorbing member 29) is arranged under the rocker outer panel 12, and an EA member 20 (energy absorbing member 20) is arranged under the rocker inner panel 11. Each of the EA members 20 and 29 is a hollow beam, and has a cornered tubular shape. As aforementioned, FIG. 2 shows the lower left structure of the vehicle body 2, and the lower right structure of the vehicle body 2 has the same structure as that of FIG. 2, That is, the vehicle body lower structure according to the embodiment has the pair of rockers 10, and the pair of EA members 20. Each of the EA members 20 is arranged along the corresponding rocker 10.

The power supply package 40 is arranged on a vehicle center side (center side in the vehicle-width direction) of the EA member 20. In other words, the power supply package 40 is arranged between the pair of EA members 20 (pair of rockers 10). Each EA member 20 is fastened to the corresponding rocker 10 (rocker inner panel 11) by a bolt 31 and the nut 32. The power supply package 40 is fastened together with the rockers 10 and the EA members 20 by the bolts 31 and the nuts 32. Although plural bolts are used to fasten the rocker 10, the EA member 20, and the power supply package 40 on each lateral side. FIG. 2 shows only one bolt 31. The plural bolts are aligned in a line along the vehicle front-rear direction.

The floor panel 50 covers the power supply package 40 and. a part of each EA member 20 on the vehicle center side. A remaining part of each EA member 20 is located under its corresponding rocker 10. The floor panel 50 is fixed to the rockers 10 (rocker inner panel 11).

The EA member 29 is arranged on an outer side of the EA member 20 in the vehicle-width direction. The EA member 29 is opposed to the EA member 20 with lower flanges of the rocker inner panel 11 and the rocker outer panel 12 interposed therebetween. The EA members 20 and 2.9 are configured to absorb energy exerted upon when the vehicle collides at its lateral side, thereby protecting the power supply package 40.

The EA members 20 and 29 absorb the collision energy by collapsing in the vehicle-width direction by the impact of the collision. The rockers 10 contribute to the absorption of the collision energy, however, the rockers 10 alone are insufficient for absorbing the collision energy all on their own. To address this, the hollow EA members 20, 29 are arranged along the rockers 10. The two EA members 20, 29 are employed by avoiding the lower flanges of the rocker inner panel. 11 and the rocker outer panel 12 and obtaining an appropriate width of the EA members in the vehicle-width direction.

Strengths of the EA members 20 and 29 are determined in advance by a simulation, for example, such that the members can effectively absorb the collision energy. The strengths of the BA members 20 and 29 are set lower than at least a strength of the power supply package 40.

The EA member 20 will be described in detail. As aforementioned, the EA member 20 is a hollow beam, and has a cornered tubular shape. As such, a cross section of the EA member 20 perpendicular to the front-rear direction has a same shape at any position along the front-rear direction. The EA member 20 is made by an extrusion molding method of a metal (typically aluminum).

The EA member 20 is constituted of an upper plate 21, a lower plate 22, a number of vertical plates 23, 24, 25, 26, and a number of diagonal plates 27. The upper plate 21 and the lower plate 22 intersect an axis of the bolt 31. A through hole through which the bolt 31 extends is provided in each of the upper plate 21 and the lower plate 22. The vertical plates 23, 24, 25, and 26 connect the upper plate 21 and the lower plate 22 to each other. In FIG. 2, signs are omitted from some of the vertical plates.

Each of the diagonal plates 27 is provided between a pair of adjacent vertical plates. Each diagonal plate 27 extends from an upper end of one of its adjacent vertical plates to a lower end of the other of its adjacent vertical plates. The diagonal plates 27 are provided to suppress the EA member 20, of which outer shape of the cross section is rectangular, from deforming diagonally.

The power supply package 40 is adhered to the vertical plate 26 arranged on the vehicle body center side. The power supply package 40 comprises a power supply body 41 and a bottom supporting plate 42 fixed to a bottom of the power supply body 41. The power supply body 41 is adhered to the vertical plate 26. Although details of this will be described later, the bottom supporting plate 42 extends outward beyond the. respective bolts 31 (outward in the vehicle-width direction), and is fastened together with the EA member 20 to the rocker 10. A washer 33 is arranged between a head 31a of the bolt 31 and the lower plate 22 (and the bottom supporting plate 42). The bolt 31 penetrates through washer 33.

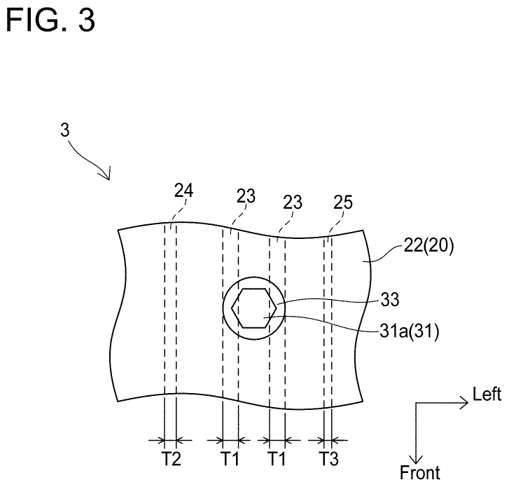

An enlarged view of a surrounding of the bolt 31 is shown in a lower side of FIG. 2. The vertical plates 23 are arranged on both sides of the bolt 31 (both sides in the vehicle-width direction). The vertical plates 23 overlap the nut 32, the head 31a , and the washer 33 as seen along an axial direction of the bolt 31 (up-down direction). FIG. 3 shows a bottom view of the surrounding of the bolt 31. In FIG. 3, the vertical plates 23, 24, and 25 are depicted in broken lines as they are hidden by the lower plate 22. As it is well depicted in FIG. 3, the vertical plates 23 overlap the head 31a, the washer 33, and the nut 32 as seen along the axial direction of the bolt 31. The other vertical plates 24 to 26 are separated away from the boll 31, and thus do not overlap the head 31a , the washer 33, nor the nut 32 as seen along the axial direction of the bolt 31.

Since the vertical plates 23 overlap the head 31a , the washer 33, and the nut 32, a fastening strength of the bolt 31 is directly applied to the vertical plates 23. The vertical plates 23 prevent deformation of the upper plate 21 and the lower plate 22 caused by the fastening strength of the bolt 31. Due to this, the hollow EA member 20 may not be deformed by the fastening strength of the bolt 31, and thus the EA member 20 is rigidly fixed to the rocker 10. This arrangement of the bolt 31 interposed between the pair of vertical plates 23 also contributes to the prevention of the deformation of the upper plate 21 and the lower plate 22.

A thickness T1 of the vertical plates 23 on both sides of the holt 31 is greater than those of the other vertical plates, that is, than a thickness T2 of the vertical plate 24 and a thickness T3 of the vertical plate 25. The thickness T1 is greater than a thickness of the vertical plate 26. Since the thickness T1 of the vertical plates 23 adjacent to the bolt 31 is great, the vertical plates 23 can sufficiently withstand the fastening strength of the bolt 31. The thickness T1 of the vertical plates 23 is greater than a thickness of the diagonal plates 27.

Meanwhile, a thickness T4 of the upper plate 21 and a thickness T5 of the lower plate 22 are smaller than the thickness T1 of the vertical plates 23. Each of the thickness T4 of the upper plate 21 and the thickness T5 of the lower plate 22 is constant along the vehicle-width direction. When the vehicle collides on its lateral side, the EA member 20 absorbs the collision energy by deforming the upper plate 21 and the lower plate 22. By configuring the thickness T4 of the upper plate 21 and the thickness 15 of the lower plate 22 small, the EA member 20 can suitably absorb the energy of the impact generated upon the lateral collision. The thickness 14 of the upper plate 21 and the thickness T5 of the lower plate 22 are equal to each other. Since the thicknesses are equal, the upper plate 21 and the lower plate 22 collapse at an equal degree as each other when the force of the lateral collision acts on the upper plate 21 and the lower plate 22. As a result of this, the EA member 20 having had the force of the lateral collision applied thereon may not bend upward or downward, but collapses by shrinking its size in the vehicle direction.

The power supply package 40 is adhered to the vertical plate 26 arranged on the vehicle body center side of the EA member 20 and is fastened to the rocker 10 and the EA member 20 by the bolt 31. As aforementioned, since the EA member 20 withstands the fastening strength by the bolt 31 well, and thus the power supply package 40 is also rigidly fixed to the rocker 10 and the EA member 20. The power supply package 40 may be supported by the frame (rockers 10) without relying on side members.

Points to be noted with regard to the art described in the embodiment will be described FIGS. 2 and 3 illustrate a structure surrounding one bolt 31. Plural bolts are provided along a longitudinal direction (vehicle body front-rear direction) of each EA member 20, and structures surrounding the respective bolt have like structures as the structure shown in FIGS. 2 and 3. The EA member 20 is arranged on each of the rockers 10 disposed on both sides in the vehicle-width (left-right) direction, and each EA member 20 has the structure of FIGS. 2 and 3.

On each lateral side in the embodiment, all of the head 31a of the bolt 31, as well as the nut 32 and the washer 33 coupled to the bolt 31 overlap at least one vertical plate 23 as seen along the axial direction of the bolt 31. The aforementioned advantage may be expected so long as at least a part of each of the head 31a , the nut 32, and the washer 33 overlaps a part of the at least one vertical plate 23. The aforementioned advantage may be expected so long as at least one of the head 31a , the nut 32, and the washer 33 overlaps the at least one vertical plate 23. It is preferable that one of the head and the washer (one of the nut and the washer on a nut side) overlaps the at least one vertical plate on both of a bolt 31 head side and the nut side. It is more preferable that the head (nut) overlaps the at least one vertical plate rather than the washer.

The power supply package 40 of the vehicle body lower structure 3 of the embodiment houses batteries therein. The power supply package 40 may be a device which houses fuel cells therein.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle body lower structure comprising:
a rocker arranged at a lower lateral part of a vehicle body and extending along a front-rear direction of the vehicle body;
a power supply package arranged under a floor panel of the vehicle body; and
a hollow beam extending along the front-rear direction and fixed to the power supply package, the hollow beam including an upper plate, a lower plate, and a vertical plate, and the vertical plate connecting the upper plate and the lower plate;
wherein
the hollow beam is fixed to the rocker by a bolt penetrating the upper plate and the lower plate, and.
a head of the bolt overlaps the vertical plate in an axial direction of the bolt, and/or a washer through which the bolt extends overlaps the vertical plate in the axial direction.

2. The vehicle body lower structure of claim 1, wherein
the vertical plate comprises a pair of vertical plates, and
the bolt extends between the pair of vertical plates.

3. The vehicle body lower structure of claim 1, wherein the power supply package is fixed together with the rocker to the hollow beam by the bolt.

4. The vehicle body lower structure of claim 1, wherein
the hollow beam includes an additional vertical plate connecting the upper plate and the lower plate,
the additional vertical plate is located apart from the head and/or the washer as seen along the axial direction, and
a thickness of the vertical plate is greater than a thickness of the additional vertical plate.

5. The vehicle body lower structure of claim 1, wherein a thickness of at least one of the upper plate and the lower plate is constant in a lateral direction of the vehicle body.

6. The vehicle body lower structure of claim 1, wherein a cross section of the hollow beam perpendicular to the front-rear direction has a same shape at any position along the front-rear direction.

7. The vehicle body lower structure of claim 1, wherein the hollow beam is made by an extrusion molding method of a metal.
